(19) United States
(12) Patent Application Publication
(10) Pub. No.: US 2009/0026866 A1
(43) Pub. Date: Jan. 29, 2009

(54) TRANSVERSE FLUX MACHINE AND METHOD FOR MANUFACTURING SAME

(76) Inventors: Ingolf Groening, Lohr am Main (DE); Christian Kaehler, Wuerselen (DE)

Correspondence Address: Striker, Striker & Stenby, 103 East Neck Road, Huntington, NY, 11743, US

(21) Appl. No.: 12/174,147

(22) Filed: Jul. 16, 2008

(30) Foreign Application Priority Data
Jul. 24, 2007 (EP) 07 014 493.6

(51) Int. Cl. H02K 21/12

(52) U.S. Cl. 310/156.02

(57) ABSTRACT

A transverse flux machine with a primary part and a secondary part (300), which moves in relation to the primary part, with the primary part or secondary part (300) including a coil arrangement equipped with at least one phase module (100; 600), in which a phase module (100; 600) has a phase module winding (606), a phase module back iron (101; 601), and at least one pair of pole elements (102; 602) that constitutes a pole element pair (105; 605); each pole element (102; 602) has a pole element back iron (103; 603) extending from the phase module back iron (101; 601) in perpendicular fashion and a pole element leg (104; 604) extending parallel to the phase module back iron (101; 601); the phase module back iron (101; 601), together with each pole element (102; 602), forms a respective, essentially C-shaped cross section; the phase module winding (606) is at least partially situated inside the essentially C-shaped cross section; the pole elements (102; 602) of the at least one pole element pair (105; 605) are situated in alternating fashion on the phase module back iron (101; 601); and the phase module back iron (101; 601), together with the two pole elements (102; 602) of the at least one respective pole element pair (105; 605), forms an essentially rectangular cross section; and a method for manufacturing same.

The invention relates to a transverse flux machine with a primary part and a secondary part, which moves in relation to the primary part, and also relates to a method for manufacturing same.

### PRIOR ART

A transverse flux machine (TFM) is usually composed of a fixed primary part (stator) and a moving or rotating secondary part (rotor), one of which has permanent magnets and the other of which is provided with a coil winding extending in the movement or rotation direction. A transverse flux machine is usually equipped with a one-phase, two-phase, or three-phase coil arrangement, i.e. that has one, two, or three phase windings, the individual phase windings of the coil arrangement usually being magnetically and electrically insulated from the other phase windings.

A rotary transverse flux machine of a known type has a stator with three electrically and magnetically insulated phase windings extending in the circumference direction, each of which is situated in a respective iron yoke for magnetic flux guidance. The yokes are usually U-shaped or C-shaped and can be composed of solid material or of individual plates joined to one another. The yokes open in the radial direction, i.e. perpendicular to the rotation axis of the machine. The legs of the yokes are therefore oriented in the direction of the rotor provided with the permanent magnets, the magnetically active area being determined by the end surfaces of the yoke legs. Due to the above-described form of the yoke, these end surfaces are relatively small, which limits the performance and force density of the machines and results in a powerful torque ripple.

The insertion of the phase windings into the yoke also requires a large amount of effort since the yoke legs are usually composed of stamped plates and the end surfaces are consequently sharp-edged, which can lead to damage to the windings during insertion. A beveling of the end surfaces is disadvantageous since this further reduces the magnetically active area.

In order to prevent winding damage, the windings of the individual phases are as a rule either inserted already wound with a larger or smaller diameter into the prepared yoke of the machine, which results in a reduced copper fill factor, or are wound into the prepared C-yokes of the transverse flux machine, which entails a greater production expense.

In a linear TFM, the windings do not extend in a circular fashion, but rather in an oval fashion on the back iron or return in an inverted phase so that a linear TFM corresponds to an “unwound” rotary TFM and therefore has the same disadvantages.

The object of the present invention, therefore, is to disclose a transverse flux machine in which the above-mentioned disadvantages are reduced and which assures a higher force density with a reduced torque ripple and a simpler assembly.

This object is attained by a transverse flux machine and a method for manufacturing same that have the defining characteristics of the independent claims. Advantageous embodiments are the subject of the dependent claims and of the following description.

The transverse flux machine according to the invention has a primary part and a secondary part, which moves in relation to the primary part, with the primary part or the secondary part including a coil arrangement equipped with at least one phase module. A phase module has a phase module winding, a phase module back iron, and at least one pair of pole elements that constitutes a pole element pair. Each pole element has a pole element back iron extending from the phase module back iron in perpendicular fashion and a pole element leg extending parallel to the phase module back iron; the phase module back iron, together with each pole element, forms a respective, essentially C-shaped cross section. The phase module winding is at least partially situated inside the essentially C-shaped cross section and the pole elements of the at least one pole element pair are situated on the phase module back iron in alternating fashion. The phase module winding therefore extends essentially between the legs of the C-shaped cross section.

The pole elements of a pole element pair consequently extend essentially in an L-shape from the phase module back iron so that the legs of the L-shape and C-shape are arranged in alternating opposition and the pole elements, together with the phase module back iron, constitute a rectangle in cross section.

Several terms will be introduced below for the sake of better comprehension. In the context of this invention, a phase winding is characterized in that it is provided for connecting an electrical phase, e.g. U, V, or W in three-phase current. It can be composed of one or more phase module windings. In this context, the combination of all of the phase module windings that are to be connected to this same phase constitute one phase winding. Likewise, all of the phase modules whose phase module windings constitute one phase winding, combine to comprise one phase module group. For example, in a three-phase machine with a total of nine phase modules, there are three phase module groups, each with three phase modules: UUU, VVV, and WWW. In the example mentioned here, the phase modules in the machine can, for example, be grouped (UUUVVVWWW) or arranged in alternating fashion (UVWUVWUVW). A phase module group in the context of this invention can also be composed of a single phase module. The coil arrangement has a number of phase windings that corresponds to the number of power supply phases, e.g. it has three phase windings in the case of three-phase current. The rotor can likewise include a coil arrangement, but preferably has an arrangement of permanent magnets.

### ADVANTAGES OF THE INVENTION

The embodiment of a transverse flux machine according to the invention significantly simplifies the manufacture and assembly of a transverse flux machine of this kind and minimizes the risk of an incorrect assembly. The copper fill factor is significantly increased. Both of these result in an increased performance with simultaneously reduced manufacturing costs. The force density of the machine is improved and the torque ripple is reduced.

In particular, it is possible to pre-wind and insulate the individual phase module windings before the assembly of the machine and then to insert them, already wound, into the phase modules; this makes it possible to achieve a higher copper fill factor and also to avoid or prevent damage to the winding. The placement and orientation of the opening of the C-shaped cross section away from the magnetic flux direction defines the magnetically active area by means of an outside of a pole element leg, thus significantly increasing it. This also achieves a decoupling of the iron volume and copper volume thus permitting them both to be adapted independently of each other to the desired application field of the machine. In particular, because of the larger effective area of iron, the machine does not reach saturation until later, making it suitable for both long-term applications and for servo applications (S1 and S6).

The pole elements are arranged in alternating fashion around the phase module winding; the C-shaped cross section thus opens in opposite directions in alternating fashion. The pole element back iron of the individual pole elements always passes the phase module winding on the right and left in alternating fashion. It is suitable for the pole elements that open and are oriented in one direction to be provided or attached to the phase module back iron first, then for the phase module winding to be inserted, and finally, for the pole elements that open and are oriented in the other direction to be provided. In the transverse flux machine according to the invention and the method for manufacturing same, a number of phase modules can be arranged independently of one another and in sequence in a machine, which further increases the advantages mentioned above.

The application fields of a transverse flux machine according to the invention are not limited, but instead extend to all applications in which electric motors can be used, including all linear, rotary, and solenoid sectors. A preferred, but non-limiting application field of one embodiment of a transverse flux machine according to the invention is the sector of industrial drive units, particularly in sizes 10 to 380. A preferred exemplary embodiment of this kind is embodied in the form of a three-phase drive unit with approximately 3×380 volts to 3×480 volts and a speed range of approximately 0 to 30,000 rpm.

The phase module back iron, together with the two pole elements of the at least one pole element pair, constitute a preferably rectangular cross section. This rectangular cross section has the advantage that the coils can be simply manufactured and prefabricated. It is also possible for the coils to be easily assembled in a plurality of work steps such that initially, all of the first pole elements 102 oriented in the same direction are placed onto the back iron 101, then the prefabricated winding is inserted, and finally, all of the second pole elements 104 oriented in the opposite direction from the first pole element are put in place.

According to a preferred embodiment, the phase module winding of the at least one phase module is arranged in a meandering fashion along and around the pole elements. The expression “meandering” is understood in the context of this invention to be both the classic orthogonal form of a meander and also a rounded, sinuous form, which is in particular referred to as a “running dog.” The meandering arrangement provides the phase module winding with a larger amount of space, which makes it possible to achieve a higher copper fill factor, without having to eliminate magnetically active iron area. This makes it very advantageously possible to increase the force density of the machine.

At least one pole element is suitably attached to the phase module back iron in a frictionally engaging, form-locked, or integrally joined fashion, preferably in a frictionally engaging fashion. It is particularly advantageous to provide the phase module back iron with suitable openings for the insertion of the pole elements, with the pole elements being embodied as L-shaped, but preferably C-shaped. A C-shaped pole element in this case has a pole element back iron and two pole element legs extending from it in essentially perpendicular fashion, whereas an L-shaped pole element has a pole element back iron and one pole element leg extending from it in essentially perpendicular fashion. For the frictionally engaged fastening, the phase module back iron provided with openings can be heated in order to enlarge the openings, whereupon a leg of a C-shaped pole element or the tip of the pole element back iron of an L-shaped pole element is inserted into the corresponding opening. After the cooling of the phase module back iron, a frictionally engaging connection is produced, which avoids the complex fastening e.g. by means of screws, welding, and the like. This makes it possible to reduce the weight of the transverse flux machine.

It is advantageous if a pole element leg of at least one pole element is beveled or chamfered on an inner edge. This can further facilitate the insertion of the phase module winding and makes it possible to further reduce potential damage to the phase module winding. The beveling can be embodied without loss of magnetically active area, making it possible to assure a reliable, damage-free insertion of a phase module winding. A beveling is advantageously provided on all inner pole element edges that could cause damage to the phase module winding. It is also advantageous to embody the form of the pole elements in such a way that the force density is further increased and the torque ripple is further decreased. For example, the leg of the pole element oriented toward the rotor can be embodied in the form of a triangle or a sector of a circle in order to reduce the torque ripple.

In a rotor provided with a permanent magnet arrangement, a suitable approach is to select the form and embodiment of the permanent magnets so that the force density is further increased and the torque ripple is further decreased. To this end, it has turned out to be advantageous to use shell magnets with and without bevels, in an inclined arrangement or a butterfly arrangement.

Particularly preferably, the at least one phase module has at least three pole element pairs spaced irregular distances apart from one another. It is additionally or alternatively possible for the spacing of the two pole elements of a pole element pair to be varied for different pole element pairs of a phase module. This so-called pole element pair offset or pole element offset can likewise reduce the torque ripple. The offset is selected so as to reduce oscillations and harmonics in the resulting action of forces of the transverse flux machine. The advantageous action of the pole element pair offset and/or of the pole element offset can likewise be achieved through an offset of the magnets on the rotor. The magnet offset can therefore be alternatively or additionally provided.

A transverse flux machine according to the invention advantageously has a pole coverage of approx. 30% to approx. 90%, in particular approx. 55% to approx. 60%, advantageously approx. 58%. A pole coverage of this kind has turned out to be advantageous for the achievement of a high force density within minimized torque ripple.

In a transverse flux machine embodied in the form of a rotating machine equipped with at least one phase module group having a number n of phase modules, it is particularly advantageous for the phase modules to be respectively situated so that they are electrically rotated in relation to one another by a predetermined and also varying angle βᵢ (i=1, . . . , n−1). Usually, the phase modules of a phase module group are arranged in a non-rotated fashion. In other words, in a phase module group UUU, the phase modules U have the same orientation electrically and mechanically. In order to reduce a torque ripple, it is then particularly advantageous to provide predetermined angles βᵢ, which do not all necessarily have to be of the same magnitude, between the phase modules of a phase module group in accordance with which the phase modules are rotated in relation to one another. Two phase modules are electrically rotated by an angle βᵢ in relation to each other if a pole element pair of a phase module is mechanically rotated by βᵢ in relation to the corresponding pole element pair of the other phase module. It would also be possible to implement the electrical rotation by means of a rotation in the rotor, in particular by offsetting the corresponding magnets by the angle Pi. The magnet offset can be alternatively or in additionally provided. The sum of the provided angles should equal zero, with the individual angles being suitably selected from the range extending from −20° to +20°. For example, in a phase module group UUUU that has four phase modules, an angle βᵢ=4° can be provided between the first and second phase module, an angle β₂=−3° can be provided between the first and third phase module, and an angle βᵢ=−1° can be provided between the first and fourth phase module, so that the sum of the angles βᵢ+β₂+β₃=0°. The provision of these angles is independent of the actual sequence of the phase modules and can also occur in an alternating arrangement as explained above.

In a transverse flux machine embodied in the form of a rotating machine equipped with a number m=3 of phase module groups, it is likewise advantageous for the phase modules of different phase module groups to be respectively situated so that they are electrically rotated in relation to one another by a predetermined angle (k·360°/m)+αₖ; αₖ ∈ [−15°; 15°]; k=1 . . . , m−1. Usually, the phase modules of m different phase module groups are rotated in relation to each other by the angle k·360°/m. In other words, for example in a three-phase machine, there is an electrical angle of 120° between the phase module U and the phase module V and there is an electrical angle of 240° between the phase module U and the phase module W. In order to reduce a torque ripple, it is then particularly advantageous to vary this angle k·360°/m by predetermined angles αₖ, which do not all necessarily have to be of the same magnitude. The sum of the provided angles αₖ should equal zero, with the individual angles being suitably selected from the range extending from −15° to +15°. For example, in a three-phase machine, an angle of 125° (i.e. α₁=5°) can be provided between the first phase module U and the first phase module V and an angle of 235° (i.e. α₂=−5°) can be provided between the first phase module U and the first phase module W, so that the sum of the angles α₁+α₂=0°. The provision of these angles is independent of the actual sequence of the phase modules and can also occur in a grouped arrangement, e.g. UUUVVVWWW, as explained above. It should also be clearly stated that in phase module groups with more than one phase module, the angle between the respective first phase modules does not have to be identical to the angles between the respective second phase modules, etc. It is only necessary to assure that the sum of the angles αₖ of a series, i.e. between the respective n^{th} phase modules, equals zero.

A suitable approach is to combine the angles α and β; in the context of the above-mentioned constraint, it is no longer possible to freely select from all angles; instead, the selection must be made as a function of other angles, as will be clear to a person skilled in the art who considers the matter.

The following exemplary embodiments are cited here:

| | | | |
|---|---|---|---|
| 1^{st} series | [U₁V₁W₁]: | [U₁(120° + α₁); V₁; | α₁ + α₂ = 0; |
| | | U₁(240° + α₂) W₁]; | |
| 2^{nd} series | [U₂V₂W₂]: | [U₂(120° + α₃); V₂; | α₃ + α₄ = 0; |
| | | U₂(240° + α₄) W₂]; | |
| 3^{rd} series | [U₃V₃W₃]: | [U₃(120° + α₅); V₃; | α₅ + α₆ = 0; |
| | | U₃(240° + α₆) W₃]; | |
| 1^{st} group | [U₁U₂U₃]: | [U₁(β₁)U₂; U₁(β₂) U₃]; | β₁ + β₂ = 0; |
| 2^{nd} group | [V₁V₂V₃]: | [V₁(β₃)V₂; V₁(β₄) V₃]; | β₃ + β₄ = 0; |
| 3^{rd} group | [W₁W₂W₃]: | [W₁(β₅)W₂; W₁(β₆) W₃]; | β₅ + β₆ = 0; |

—Alternating Arrangement:

[U₁V₁W₁][U₂V₂W₂][U₃V₃W₃]; in this example, the angles β₃, β₄, β₅, and β₆ result from the other angles, for example β₃ results from α₁, β₁, and α₃.

—Grouped Arrangement: [U₁U₂U₃][V₁V₂V₃][W₁W₂W₃]; in this example, the angles α₃, α₄, α₅, and α₆ result from the other angles.

In a grouped arrangement, each second phase module should be electrically and mechanically rotated by 180°, i.e. in particular, pole element back irons should be inserted into pole element back irons in order to minimize the leakage flux between the phase modules.

A method according to the invention for manufacturing a transverse flux machine with a primary part and a secondary part in particular yields a transverse flux machine according to the invention. A method according to the invention or its preferred embodiment therefore has all of the steps required to manufacture a transverse flux machine that is embodied according to the invention or is embodied in a preferred fashion.

Naturally, the defining characteristics mentioned above and explained below can be used not only in the combination indicated, but also in other combinations or by themselves, without going beyond the scope of the present invention.

An exemplary embodiment of the invention is schematically depicted in the drawings and will be described in greater detail below in conjunction with the drawings.

### DESCRIPTION OF THE DRAWINGS

FIG. 1 schematically depicts a preferred embodiment of a phase module of a transverse flux machine;

FIG. 2A schematically depicts a first preferred embodiment of a pole element;

FIG. 2B schematically depicts a second preferred embodiment of a pole element;

FIG. 3 schematically depicts a preferred embodiment of a rotor;

FIG. 4A schematically depicts a cross section through a permanent magnet arrangement of a rotor of an internal rotor machine;

FIG. 4B schematically depicts a cross section through a permanent magnet arrangement of a rotor of an external rotor machine;

FIG. 5A schematically depicts the plate structure of a pole element;

FIG. 5B schematically depicts the plate structure of a phase module back iron; and

FIG. 6 schematically depicts a meandering course of a phase module winding of a phase module.

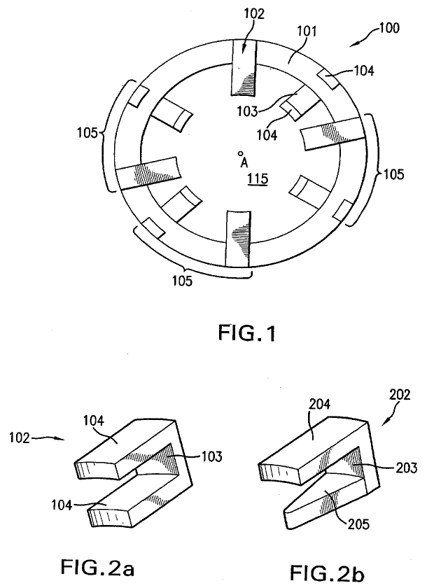

FIG. 1 is a schematically depicted top view of a part of a phase module 100 belonging to a stator. The phase module includes a phase module back iron 101 with pole elements 102 attached to it. The pole elements 102 are embodied as C-shaped, with a pole element back iron 103 and two pole element legs 104 extending essentially perpendicular to the pole element back iron and attached to the phase module back iron 101 in alternating fashion in the circumference direction. In the top view shown, therefore, the pole element back irons 103 of the pole elements 102 are situated in alternating fashion above and below the phase module back iron 101. Inside the C-shaped opening between the pole element legs 104 of the pole elements 102, a phase module winding (not shown) extends in a meandering fashion, which winding can be a component of a phase winding or a phase winding itself, depending on the number of phase modules and phase windings. The phase module winding extends in the circumference direction inside the annular phase module back iron 101 and weaves around the pole element back irons 103 in a meandering fashion. Inside the phase module 100, there is an open space 115 for accommodating a rotor (not shown) that can rotate around a rotation axis A. The pole elements 102 are grouped by twos into pole element pairs 105. In the drawing shown, the distance between the two pole elements of each pole element pair 105 is selected to be the same, but it is also possible to provide pole element pairs with different spacings of the pole elements. The phase module 100 according to FIG. 1 has four pole element pairs 105, which, according to the preferred exemplary embodiment shown, are not spaced the same distance apart from another. This arrangement is selected in order to minimize torque oscillations.

FIG. 2A provides a detailed depiction a pole element 102 according to FIG. 1. The pole element 102 is embodied as essentially C-shaped and has a pole element back iron 103 and two pole element legs 104 extending from the former in essentially perpendicular fashion. The phase module winding is routed inside the C-shaped opening. FIG. 2A shows a first exemplary embodiment of a pole element in which the pole element leg (at the bottom in FIG. 2A) oriented toward the rotor (not shown) is embodied as essentially block-shaped.

In FIG. 2B, a second preferred exemplary embodiment of a pole element is schematically depicted and labeled as a whole with the reference numeral 202. The pole element 202 essentially corresponds to the pole element 102 according to FIG. 2A, but a pole element leg 205 oriented toward the rotor is embodied as essentially sector-shaped. Another leg 204 of the essentially C-shaped pole element 202 is once again provided for being fastened to a phase module back iron. The sector-shaped embodiment of the pole element leg 205 in turn contributes to a minimization of the torque ripple. The pole element legs 204 are connected by means of a pole element back iron 203.

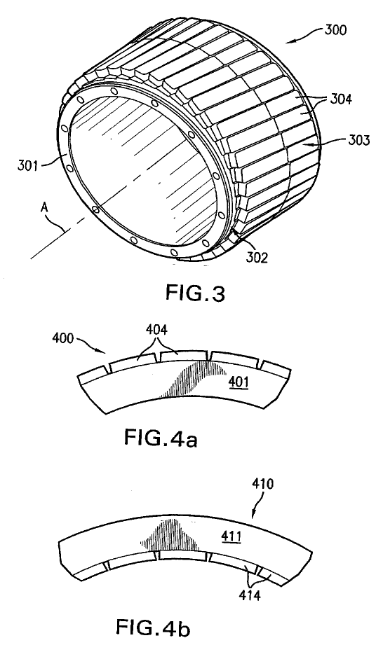

FIG. 3 shows a preferred embodiment of a rotor that is provided with permanent magnets and labeled as a whole with the reference numeral 300. The rotor 300 is suitable for a transverse flux machine according to the invention, embodied in the form of an internal rotor machine. The rotor has a rotor body 301, the outside 302 of which is provided with a permanent magnet arrangement 303. The permanent magnet arrangement 303 is composed of a two-rowed circumferential arrangement of individual permanent magnets 304. In order to reduce the torque ripple of the transverse flux machine further, the permanent magnet arrangement 303 is embodied as inclined, i.e. the individual permanent magnets 304 are inclined in relation to the rotation axis A of the rotor 300.

FIG. 4A cross-sectionally depicts a detail of an exemplary embodiment of a rotor 400 for an internal rotor machine. The rotor 400 once again has a rotor body 401 with permanent magnets 404 mounted on it. The permanent magnets 404 are embodied in the form of shell magnets with beveled edges in order to increase the force density of the transverse flux machine and to reduce the torque ripple. FIG. 4B shows an exemplary embodiment of a rotor 410 of a transverse flux machine embodied in the form of an external rotor machine. The rotor 410 has a rotor body 411 with permanent magnets 414 mounted on it. The permanent magnets 414 are once again embodied in the form of shell magnets with beveled or chamfered edges in order to increase the force density of the transverse flux machine and to reduce the torque ripple. It should be noted that the beveling in the two permanent magnet types 404 and 414 shown is embodied so that the magnet area increases toward the concave end.

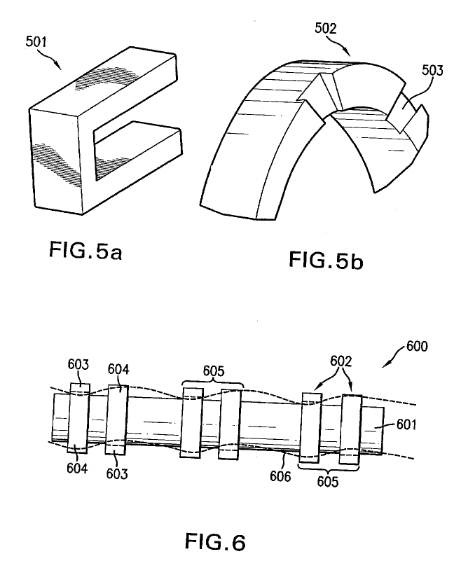

The preferred design of a pole element 501 and a phase module back iron 502 will be explained in greater detail in conjunction with FIGS. 5A and 5B, but these figures contain purely schematic depictions. The pole element 501 can in fact be composed of a solid material such as iron, but is preferably composed of plates, as depicted in FIG. 5A. In order to avoid eddy currents, the pole element 501 is composed of individually joined plates, preferably iron plates, that are electrically insulated from one another. The phase module back iron 502 is likewise composed of individual plates, in particular iron plates, that are joined to one another and electrically insulated from one another. The phase module back iron 502 is provided with recesses 503 for accommodating the pole elements. The recesses 503, like the ones in FIG. 1, are situated at the upper edge of the phase module back iron 502, but can also be situated completely within the phase module back iron.

In FIG. 6, a detail of a phase module is schematically depicted and labeled as a whole with the reference numeral 600. The phase module 600 can be a phase module of a linear transverse flux machine and can also be a phase module of a rotary transverse flux machine that is depicted in an “unwound” state. The phase module 600 has a phase module back iron 601 and pole elements 602 attached to it. The pole elements 602 are grouped into pole element pairs 605.

The phase module 600 is shown in a top view so that one pole element leg 604 is situated on top of the phase module back iron 601. The pole element back irons 603 of the pole elements 602 are situated in alternating fashion on the right and left side next to the phase module back iron.

A phase module winding 606 extends in a meandering fashion around the pole element back irons 603 along the phase module back iron 601. The phase module winding 606 is delimited in one direction by the pole element legs 604 and is delimited in the opposite direction by the phase module back iron 601. The meandering arrangement provides the phase module winding 606 with a larger amount of space than would be available to a phase module extending in a straight line.

When assembling a transverse flux machine according to the invention, preferably the phase modules are first provided with the pole elements on the outside of the machine and then with the phase module winding. Then, the completed phase modules are grouped into the desired sequence, i.e. grouped or alternating, and are inserted into the transverse flux machine housing in the desired arrangement, i.e. with an angular offset, for example. This produces a transverse flux machine that is easy to assemble and provides a high force density with a simultaneously low torque ripple.

All of the phase modules or phase module windings that are provided for connection to the same electrical phase constitute the so-called phase winding. If the transverse flux machine is provided for connection to a three-phase current, then it has three phase windings, each of which can include a plurality of phase module windings. All of the phase windings together constitute the coil arrangement of the transverse flux machine.

Naturally, only particularly preferred embodiments of the invention are shown in the drawings. Any other embodiment, in particular in the form of a linear machine, etc., is conceivable without going beyond the scope of this invention.

### REFERENCE NUMERALS

100 phase module
102 pole element
103 pole element back iron
104 pole element leg
105 pole element pair
202 pole element
204 pole element leg
205 pole element leg
300 rotor
301 rotor body
302 outside
303 permanent magnet arrangement
304 permanent magnet
400 rotor
401 rotor body
404 permanent magnet
410 rotor
411 rotor body
414 permanent magnet
501 pole element
502 phase module back iron
503 recess
600 phase module
601 phase module back iron
602 pole element
603 pole element back iron
604 pole element leg
605 pole element pair
606 phase module winding
A rotation axis

What is claimed is:

1. A transverse flux machine with a primary part and a secondary part (300), which moves in relation to the primary part, with the primary part or secondary part (300) including a coil arrangement equipped with at least one phase module (100; 600),
wherein a phase module (100; 600) has a phase module winding (606), a phase module back iron (101; 601), and at least one pair of pole elements (102; 602) that constitutes a pole element pair (105; 605);
each pole element (102; 602) has a pole element back iron (103; 603) extending from the phase module back iron (101; 601) in perpendicular fashion and a pole element leg (104; 604) extending parallel to the phase module back iron (101; 601);
the phase module back iron (101; 601), together with each pole element (102; 602), forms a respective, essentially C-shaped cross section;
the phase module winding (606) is at least partially situated inside the essentially C-shaped cross section; and
the pole elements (102; 602) of the at least one pole element pair (105; 605) are situated in alternating fashion on the phase module back iron (101; 601).

2. The transverse flux machine as recited in claim 1,
wherein the phase module back iron (101; 601), together with the two pole elements (102; 602) of the at least one respective pole element pair (105; 605), forms a cross section, in particular an essentially rectangular cross section.

3. The transverse flux machine as recited in claim 1, wherein the phase module winding (606) of the at least one phase module (100; 600) is arranged so that it meanders around the pole elements (102; 602).

4. The transverse flux machine as recited in claim 1,
wherein at least one pole element (102; 602) is attached to the phase module back iron (101; 601) in a frictionally engaging, form-locked, or integrally joined fashion, preferably in a frictionally engaging fashion.

5. The transverse flux machine as recited in claim 1,
wherein a pole element leg (104; 604) of at least one pole element (102; 602) is beveled on an inner edge.

6. The transverse flux machine as recited in claim 1,
wherein the at least one phase module (100; 600) has at least three pole element pairs (105; 605) spaced irregular distances apart from one another.

7. The transverse flux machine as recited in claim 1,
which has a pole coverage of approx. 30% to approx. 90%, in particular approx. 55% to approx. 60%.

8. The transverse flux machine as recited in claim 1, which is embodied in the form of a rotating machine and has at least one phase module group with a number n=3 of phase modules (100; 600), wherein the phase modules (100; 600) of the same phase module group are each situated so that they are electrically rotated in relation to one another by a predetermined angle βᵢ ∈ [−20°; 20°]; i=1, . . . , n−1.

9. The transverse flux machine as recited in claim 1, which is embodied in the form of a rotating machine and is equipped with a number m=3 of phase module groups,
wherein the phase modules (100; 600) of different phase module groups are each situated so that they are electrically rotated in relation to one another by a predetermined angle (k·360°/m)+αₖ;
αₖ ∈ [−15°; 15°]; k=1, . . . , m−1.

10. A method for manufacturing a transverse flux machine with a primary part and a secondary part (300), which moves in relation to the primary part, with the primary part or secondary part (300) including a coil arrangement equipped with at least one phase module (100; 600),
wherein a phase module back iron (101; 601) of the at least one phase module (100; 600) is provided with at least one first pole element (102; 602), which has a pole element back iron (103; 603) extending from the phase module back iron (101; 601) in perpendicular fashion and a pole element leg (104; 604) extending parallel to the phase module back iron (101; 601) so that the phase module back iron (101; 601), together with each first pole element (102; 602), forms a respective, essentially C-shaped cross section;
a phase module winding (606) of the at least one phase module (100; 600) is situated inside the essentially C-shaped cross section; and
the phase module back iron (101; 601) of the at least one phase module (100; 600) is provided with at least one second pole element (102; 602), which has a pole element back iron (101; 601) extending from the phase module back iron (101; 601) in perpendicular fashion and a pole element leg (104; 604) extending parallel to the phase module back iron (101; 601) so that the phase module back iron (101; 601), together with a respective first and second pole element (102; 602) forms a cross section, in particular an essentially rectangular cross section

11. The method for manufacturing a transverse flux machine as recited in claim 10,
wherein the phase module winding (606) of the at least one phase module (100; 600) is situated so that it meanders around the pole elements (102; 602
